(19) United States
(12) Patent Application Publication
(10) Pub. No.: US 2003/0113937 A1
(43) Pub. Date: Jun. 19, 2003

(54) Desiccator system having modular elements

(75) Inventors: Cary A. Kipke, Woodbury, MN (US); Madhusudan Raghavachari, St. Paul, MN (US); Jeffrey C. Pederson, Minneapolis, MN (US); Bernard A. Gonzalez, St. Paul, MN (US); Donald L. Melvin, Stillwater, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/020,522

(22) Filed: Dec. 14, 2001

(51) Int. Cl. G01N 1/00

(52) U.S. Cl. 436/175; 436/177; 436/181; 422/101; 422/99

(57) ABSTRACT

The present invention provides a device, system and method for desiccation of liquid samples. The device includes multiple concentration chambers, each having a gas inlet and a gas vent. Methods of using the device to desiccate multiple liquid samples also are provided. The device may be assembled with a processing device to form a module. Such modules may be assembled to form a system designed, e.g., to provide automated chemical analyses of liquid samples. The system is particularly useful for modular, high-throughput chemical processing, especially in the fields of genomics and proteomics.

### TECHNICAL FIELD

The present invention is directed to systems and methods for sample preparation prior to, or as part of, chemical analysis, and more particularly to systems and methods where partial or complete desiccation of multiple samples is desired.

### BACKGROUND OF THE INVENTION

Modern analytical chemistry has evolved toward procedures in which parallel operations are performed on numerous different samples more or less simultaneously. The rise of proteomics and genomics has accelerated this trend, and it is well known in these arts to use trays or plates having an array of sample wells to contain liquid samples including, for example, biological material. Thus, it is possible to perform one or more analytical steps (e.g., adding buffers or other fluids, selectively depleting one or more components, concentrating liquids, or chemical modifications) on each of the sample wells conveniently and simultaneously. Certain standardized arrays (having, e.g., 96, 384, or 1536 wells, etc.) have gained such acceptance among practitioners that analytical instruments are dedicated to perform operations using trays or plates having such standardized arrays and may be poorly adapted for using other types of sample containers.

In particular, high speed sample concentrators may be adapted to promote solvent evaporation from the sample wells of plates or trays in which the wells are arranged into a standardized array. Such a high speed sample concentrator may inject gas through an array of needles and into the sample wells in order to promote evaporation of the sample. The array of needles may be arranged to be compatible with an array of wells in a standard 96- or 384-well plate. A needle typically enters a well through an opening at the top of the well and injects gas under pressure near the surface of the liquid samples. Thus, cross-contamination between adjacent wells may occur if some of a sample is driven out of its well by the force of the injected gas. Cross-contamination also may occur between wells of different plates if some of a sample adheres to the needle, e.g., as the result of sample splashing within the well from the force of the injected gas.

Additionally, such a high speed sample concentrator is not designed for high-throughput analyses. The concentrator and the sample plate or tray are discrete devices; plates bearing samples that require desiccation must be brought to the concentrator and then taken elsewhere for subsequent processing steps. Such transfer of the sample plates renders the analytical procedure relatively labor-intensive and, therefore, less suited to high-throughput analyses.

A need exists for a device that permits desiccation of a liquid sample that minimizes the likelihood of cross-contamination between samples. A further need exists for a desiccation device that is suited for high-throughput analyses.

### SUMMARY OF THE INVENTION

The present invention provides a device useful for desiccating liquid samples that reduces the likelihood and extent of cross-contamination between sample wells. The desiccation device may be a module of a high-throughput analytical system, the module being physically interlocked and in fluid communication with other modules designed to perform other steps in the preparation or analysis of the samples. The flow of desiccating gas is provided through an inlet to a volume above the sample.

In a first aspect, the present invention provides a desiccation device. This desiccation device includes a body that includes a plurality of chambers wherein at least one chamber is a desiccation chamber that includes: a sidewall that at least partially defines a first volume, a second volume in direct fluid communication with the first volume, and a sample volume in direct fluid communication with the second volume, wherein the second volume separates the first volume from the sample volume; at least one gas inlet located in the sidewall of the desiccation chamber and in direct fluid communication with the first volume; a gas vent in fluid communication with the first volume; and a sample opening in fluid communication with the sample volume.

In some embodiments, the desiccation device is a module that includes at least one concentrator element and at least one processing element. The concentrator element includes a body that includes a plurality of concentrator chambers, each concentrator chamber including: a sidewall located between generally opposed openings that at least partially defines the first volume, at least one gas inlet located in the sidewall and in direct fluid communication with the first volume, and a gas vent in fluid communication with the first volume. The processing element includes a body that includes a plurality of processing chambers formed in the body, wherein each processing chamber includes the sample volume and at least a portion of the second volume. The processing element may be configured so that when the concentrator element is assembled with the processing element to form the module, one or more processing chambers is in direct fluid communication with one or more concentrator chambers.

In a second aspect, the present invention provides a method for desiccating a liquid sample. A device is provided that includes a plurality of chambers formed therein, each chamber of the plurality of chambers including a sidewall. While not required in order to practice the method of the invention, it may be convenient for the plurality of chambers to be provided so that it conforms to a standardized format, e.g., having 96, 384 or 1536 wells. A liquid sample is provided in a sample volume of one or more chambers. Each chamber having a sample includes a first volume and a second volume, wherein the second volume separates the first volume from the sample volume. Next, a desiccation gas is introduced into the first volume of each chamber having a sample to be desiccated. The gas is introduced through an inlet located in the sidewall and in direct fluid communication with the first volume, thereby at least partially desiccating the liquid sample.

Because the device may have a plurality of sample wells, the method of the present invention permits multiple liquid samples to be desiccated simultaneously.

In a third aspect, the invention provides a modular sample processing system capable of processing multiple liquid samples simultaneously. The system includes two or more sample processing modules, at least one of which includes a concentrator element. Thus, in this aspect, the present invention may be suitable for modular, high-throughput chemical processing.

Various other features and advantages of the present invention should become readily apparent with reference to the following detailed description, claims and appended drawings. In several places throughout the specification, guidance is provided through lists of examples. In each instance, the recited list serves only as a representative group and should not be interpreted as an exclusive list.

### BRIEF DESCRIPTION OF THE DRAWINGS

FIG. 1 is an exploded perspective view of a sample processing module according to the present invention.

FIG. 2 is a top cross-section view of the main portion of the concentrator element of the sample processing module of FIG. 1, revealed along section lines 2-2.

FIG. 3 is a bottom cross-section view of the main portion of the concentrator element of the sample processing module of FIG. 1, revealed along section lines 3-3.

FIG. 4 is a cross-section side view of a portion an assembly including a concentrator element and a processing element, revealed along section lines 4-4.

FIG. 5 is a cross-section side view of an alternative embodiment of the concentrator element of the present invention.

FIG. 6 is a schematic is a complete modular system for proteomic analysis which includes a concentrator module according to the present invention.

FIG. 7 is a block diagram illustrating the design of a system according to the present invention

### DETAILED DESCRIPTION OF ILLUSTRATIVE EMBODIMENTS OF THE INVENTION

The present invention provides a device capable of desiccating multiple liquid samples. As used herein, “desiccating” shall mean removing solvent from a liquid sample. The solvent may be any solvent, including, but not limited to, water. “Desiccating” shall refer to removing all or any portion of the solvent present in the sample. Thus, as used herein, desiccating a sample may result in concentration of solutes in the sample. The device of the present invention may be adapted to be able to desiccate multiple liquid samples simultaneously. The present invention also provides a novel method of desiccating multiple liquid samples that permits simultaneous desiccation of the samples.

Accordingly, the device and the methods of the present invention are suited for high-throughput processing of liquid samples. Such processing may involve a modular system of processing elements such as the desiccation device of the present invention. The modular system may be automated with the various processing steps being regulated by a control element such a programmable microprocessor.

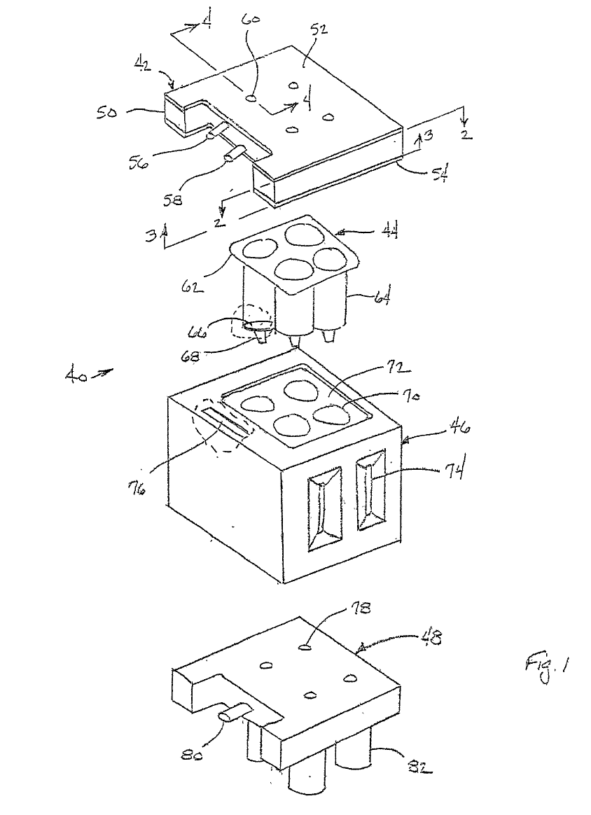

FIG. 1 illustrates an exploded perspective view of one illustrative sample processing module 40 according to the present invention. The sample processing module 40 includes a concentrator element 42, a processing element 44, a support 46, and a sample collection element 48.

The concentrator element 42 may include a main portion 50, a top cover 52, and bottom cover 54. The main portion 50 includes an inlet connection 56 and an outlet connection 58. The depicted embodiment includes liquid sample introduction ports 60.

The processing element 44 has a body 62 having a plurality of processing chambers 64, each processing chamber defining a sample volume. A drain element 66 may be provided in one or more of the processing chambers 64, providing a boundary between the sample volume and a drain port 68. The drain element 66 may include a valve that may be used to regulate movement of the sample from the processing chamber 64 to the sample collection element 48 so long as the sample includes a sufficient amount of solvent to remain substantially liquid. Alternatively, or in addition to a valve, the drain element may include a membrane capable of filtering the liquid sample as the sample is drained from the processing chamber 64.

The support 46 has a plurality of receptacles 70 for receiving the processing chambers 64 of the processing element 44. The support 46 may include a counterbore 72 for receiving body 62 when the processing chambers 64 are positioned within the receptacles 70. Windows 74 may be provided so that the user can observe the contents of processing chambers 64 after they have been positioned within the receptacles 70. A temperature control device 76 may be present to control the operating temperature of the processing chambers 64.

The sample collection element 48 includes inlet ports 78 that may be complementary to the drain ports 68 of the processing chambers 64, thereby permitting assembly of the processing element 44, the support 46 and the sample collection element 48 into an integrated processing module, described more completely below. Additionally, the inlet ports 78 may be configured to be able to provide fluid communication between the drain ports 68 of processing chambers 64 and a plurality of sample vials 82. In certain embodiments, an airtight seal may be formed between the inlet ports 78 and the drain ports 68 when the sample collection element 48 is placed in contact with the support 46. In such embodiments, a vacuum connection 80 may provide a vacuum in the assembled module, thereby drawing liquid sample from the processing chambers 64 through the drain element 66, if present, and into sample vials 82. The sample collection element 48 may be configured to be able to further desiccate the samples in the sample vials 82.

The concentrator element 42, processing element 44 and the sample collection element 48 may be constructed of any material capable of providing support and being relatively inert to the liquid samples. Suitable materials include, but are not limited to, thermoplastic materials, glass and metals. The elements may be formed from thermoplastic materials by injection molding. Suitable thermoplastic materials include, but are not limited to, polystyrenes, polyvinyl chlorides (including homo- and co-polymers thereof), polyethylenes, polypropylenes, polyvinylidene chlorides, polycarbonates and polyether sulfones. The walls of the device may be uncoated or, alternatively, may include a coating selected to reduce nonspecific adsorption of biological molecules to the device. Suitable coatings include, but are not limited to, fluoropolymers and polyethylene glycol.

The support 46 may be constructed of any suitable supportive material. In certain embodiments, the support 46 may include one or more elements, such as a temperature control device 76 shown in FIG. 1, designed to help regulate the physical environment of the processing chambers 64 being supported by the support 46. Accordingly, the materials selected for use in constructing the support 46 should be suitable for providing such regulation of the physical environment of the processing chambers 64, when such regulation is desired.

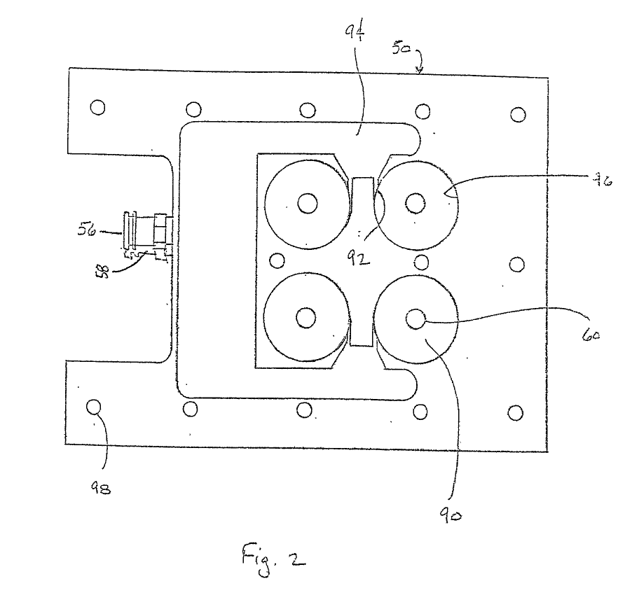

FIG. 2 illustrates a top cross-sectional view of the main portion 50 of the concentrator element 42. The main portion 50 of the concentrator element includes a plurality of concentrator chambers 90. FIG. 2 illustrates a concentrator element 42 having four concentrator chambers 90 for ease of illustration. In some embodiments, the concentrator element 42 may conform to a standardized array format, e.g., having 96, 384 or 1536 chambers. The concentrator element 42 may have any desired number of concentrator chambers arranged in any desired configuration, however.

Each concentrator chamber 90 has at least one gas inlet 92 in fluid communication with an inlet connection 56. Multiple gas inlets 92, in some cases from multiple concentrator chambers 90, may be connected to the inlet connection 56 by a supply plenum 94. The gas inlet 92 may be configured in any manner suitable for permitting the gas inlet 92 to deliver desiccation gas to the concentrator chamber 90. For example, the gas inlet 92 may be configured so that desiccation gas entering a concentrator chamber 90 does so along a line parallel to the tangent of the sidewall 96 of the concentrator chamber 90, as shown in FIG. 2. In certain embodiments, the gas inlet 92 is configured to direct desiccation gas into the concentrator chamber 90 in a direction that is substantially tangential to the sidewall 96 at the gas inlet 92. Such a configuration may cause the desiccation gas to form a vortex in the concentrator chamber 90, which may increase the rate at which the liquid sample is desiccated. However, the gas inlets 92 may deliver gas to the concentrator chamber 90 in any suitable direction.

The top cover 52 and the bottom cover 54, when present, may be assembled with and fastened to the main portion 50 in any suitable manner to form the concentrator element 42. For example, holes 98 may be provided in the main portion 50 that align with similarly configured holes in the top cover 52 and bottom cover 54. Any suitable fastening means including, but not limited to, screws may be used to fasten the main portion/top cover/bottom cover assembly. Alternatively, the main portion 50 may be constructed to include a top cover 52, bottom cover 54, or both that do not require fastening. Also, outer surfaces provided by adjacent elements or modules, when assembled with the main portion 50, may function as one or more covers for the main portion 50.

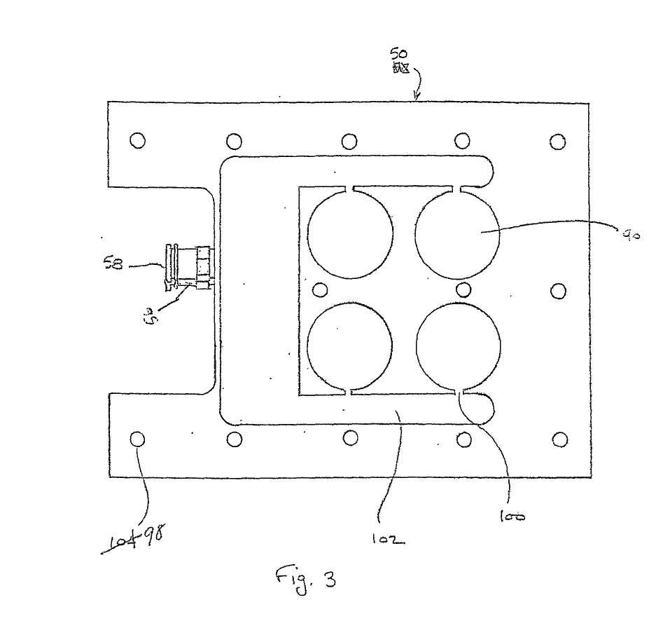

FIG. 3 illustrates a bottom cross-sectional view of the main portion 50 of the concentrator element 42. Each concentrator chamber 90 has at least one gas vent 100. The gas vent 100 may be in fluid communication with an outlet connection 58. Multiple gas vents 100 may be connected to the outlet connection 58 through a vent plenum 102. The outlet connection 58 may be connected to a vacuum source. Alternatively, the gas vent 100 may be any port or opening that provides fluid communication between the concentrator chamber 90 and the external environment.

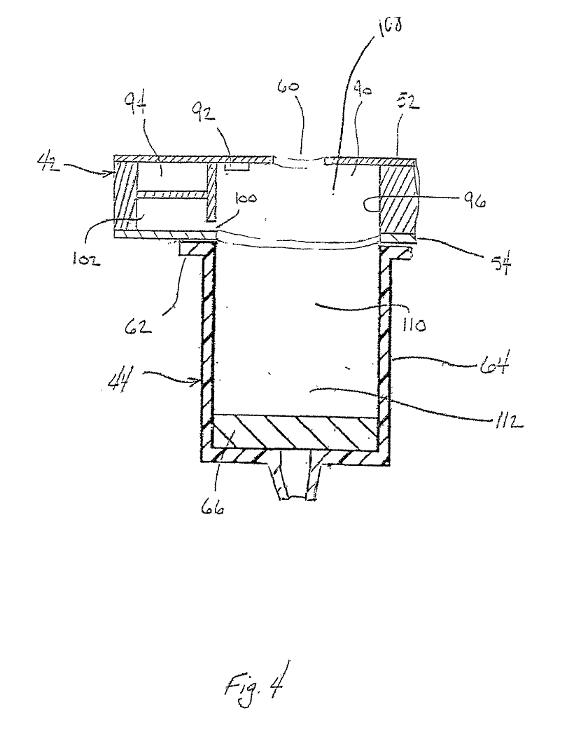

FIG. 4 illustrates a cross-sectional side view of a portion of a two-part processing module including a concentrator element 42 in connection with a processing element 44. FIG. 4 shows a single concentrator chamber 90 that defines a first volume 108 positioned above a second volume 110, which is defined by a portion of processing chamber 64 in the depicted embodiment. When the concentrator element 42 and the processing element 44 are assembled as shown in FIG. 4, the first volume 108 and the second volume 110 are continuous. However, when the concentrator element 42 and the processing element 44 are disassembled, the first volume 108 and the second volume 110 are separable. Thus, the concentrator element 42, which may have relatively complex construction, may be separated from the processing element 44 and reassembled with another processing element for reuse. The processing element 44, which may be the only portion of the module to contact the liquid sample, may be disposable following a single use.

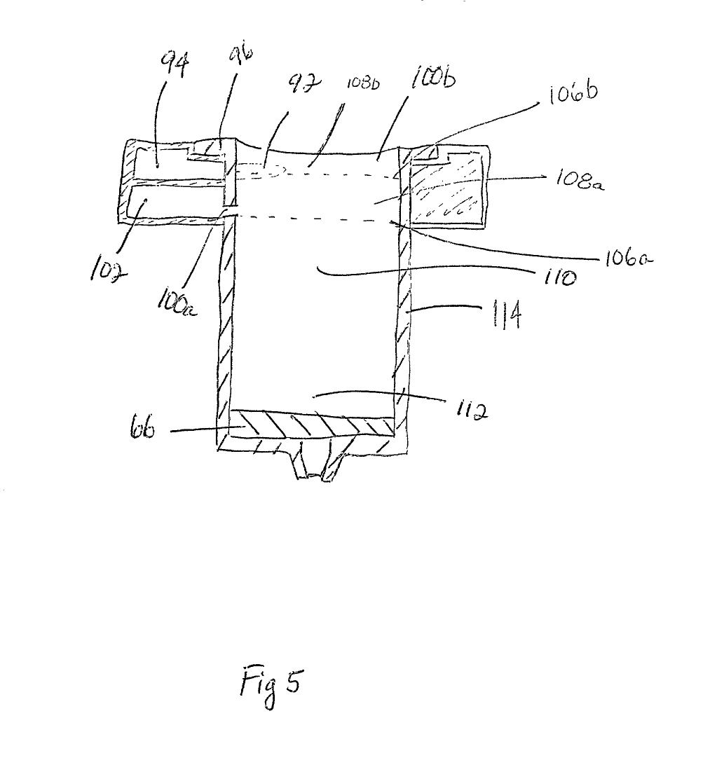

FIG. 5 illustrates an alternative, one-part processing module in which the concentration chamber and processing chamber are combined into a single chamber 114, divisible into the first volume 108, second volume 110 and sample volume 112. In contrast to the two-part module shown in FIG. 4, the first volume 108 and second volume 110 are not separable in the one-part module shown in FIG. 5. The combined chamber 114 has at least one gas inlet 92 and at least one gas vent 100.

The first volume 100 is separated from the sample volume 112 by the second volume 110. The boundary between the first volume 108 and the second volume 110 is defined, in part, by a line extending horizontally across the chamber 114 from the gas inlet 92 or the gas vent 100. If the gas inlet 92 and the gas vent 100 are positioned substantially along the same horizontal plane, i.e., the gas inlet 92 and the gas vent 100 are substantially equidistant from the sample volume 112, then the boundary between the first volume 108 and the second volume 110 is determined by this plane. If the gas inlet 92 and the gas vent 100 are not equidistant from the sample volume 112, the boundary between the first volume 108 and the second volume 110 is determined by whichever of the gas inlet 92 and the gas vent 100 is closer to the sample volume 112.

For example, FIG. 5 shows a combined chamber 114 having a gas inlet 92 and two possible locations for a gas vent, 100a and 100b. If the gas vent is located at 100a, the gas vent 100a is closer to the sample volume 112 than is the gas inlet 92. In this case, the boundary between the first volume 108a and the second volume 110 is located at 106a. In an alternative embodiment, the gas vent 100b may be an opening at the top of the chamber 114. In this case, the gas inlet 92 is closer to the sample volume 112 than is the gas vent 100b. Thus, the boundary between the first volume 108b and the second volume 110 is located at 106b. In all cases, the second volume 110 separates the first volume 108 (a or b) from the sample volume 112. The second volume 110 provides clearance between the sample volume 112 and both of the gas inlet 92 and the gas vent 100 (a or b) so that agitation of the liquid sample during desiccation is less likely to result in loss of a portion of the sample through the gas inlet 92 or the gas vent 100 (a or b).

The absolute and relative positions of the gas inlet 92 and the gas vent 100 are unimportant. Each of the gas inlet 92 and the gas vent 100 may be located anywhere in the sidewall 96 of the chamber 114 that provides sufficient clearance for the second volume 110. The gas vent 100 may be located on the sidewall 96 of the chamber 114 or may be an opening at the top of the chamber 114, as shown in FIG. 5. Thus, in some embodiments, the gas inlet 92 may be closer to the sample volume than is the gas vent 100. In other embodiments, the gas vent 100 may be closer to the sample volume 112 than is the gas inlet 92.

The sample volume 112 may be supported, whether in the processing chamber 64 of the two-part module shown in FIG. 5 or the combined chamber 114 of the one-part module shown in FIG. 4, by any suitable supporting means including, but not limited to, the drain element 66.

The drain element 66, when present, may include a valve for regulating passage of the liquid sample from the sample volume 112 to the drain port 68. A valve may be constructed of any material suitable for providing a regulatable barrier to the liquid sample. In order to provide a valve function, the material may prevent the liquid sample from passing from the sample volume 112 to the drain port 68 under certain conditions. However, under different conditions, the valve permits the liquid sample to pass from the sample volume 112 to the drain port 68.

The drain element 66, when present, also may include a membrane suitable for providing desired functions. For example, certain membranes may act to filter the liquid sample as it passes from the sample volume 112 into the drain port 68, thereby removing one or more substances from the sample that are undesirable for further processing of the sample, e.g., precipitates, cell debris or other particulates, although other types of substances may be removed by a filtering membrane. Alternatively, or in addition to providing a filtration function, a membrane may be activated so that it includes attached or embedded chemical species capable of interacting with one or more of the solutes in the liquid sample. For example, an activated membrane can have hydrophobic groups attached to it that can selectively attract relatively hydrophobic chemical species in the liquid sample while allowing relatively hydrophilic chemical species to pass through the membrane, thereby effecting at least partial separation or purification of the hydrophobic chemical species from the liquid sample. An active membrane also can contain chemical functionality, thereby allowing one to design the membrane to attract specific molecules from the liquid sample as it passes through the membrane.

Certain membranes may act as a valve for regulating the movement of the liquid sample from the sample volume 112 to the drain port 68. A membrane may be suitable for use as a valve if, for instance, it is made of a high surface energy material such as poly(tetrafluoroethylene). Such a membrane may act as a barrier to an aqueous sample under ambient pressure due to the high surface energy of the membrane material. However, if a pressure gradient is applied across the membrane, e.g., high pressure applied, directly or indirectly, through the sample volume 112 or low pressure, applied directly or indirectly, through the drain port 68, the sample may cross the membrane. Certain materials may be suitable for use as a valve, a filter, such as those reported in U.S. Pat. No. 5,248,428, U.S. Pat. No. 5,529,686 and U.S. Pat. No. 5,635,060.

The device described herein provides a convenient tool for simultaneously desiccating multiple liquid samples according to the methods of the present invention. A liquid sample may be introduced into one or more chambers of the device through a sample opening 60. If the two-part device is being used, the concentrator element is attached to the processing element to form the module illustrated in FIG. 4. A supply of desiccation gas is introduced to the concentrator chambers 90 through the gas inlet 92 of each chamber 90 via the inlet connection 56. Contact between the desiccation gas and the liquid sample provides desiccation of the sample. As previously described, the gas inlet 92 may be configured so that desiccation gas introduced into the concentrator chamber 90 creates a vortex in one or more of the first volume 108, second volume 110 and the liquid sample. Formation of such a vortex may increase the rate at which the liquid sample is desiccated. Because each chamber is physically separated from other chambers by the sidewalls 96, desiccation of the samples is achieved with substantially reduced risk of cross-contamination.

One feature of the method of the present invention is that liquid samples in two or more chambers may be at least partially desiccated simultaneously. Thus, desiccation gas may be provided to each of multiple chambers containing a liquid sample simultaneously. This may be done conveniently by, e.g., providing a supply plenum 94 that provides fluid communication between the inlet connection 56 and gas inlets 92 of two or more chambers 90 to which simultaneous delivery of desiccation gas is desired. Desiccation gas also may be removed from each of multiple chambers containing a liquid sample simultaneously. This may be done conveniently by, e.g., providing a vent plenum 102 that provides fluid communication between the outlet connection 58 and gas vents 100 of two or more of the concentrator chambers 90 from which simultaneous removal of desiccation gas is desired.

In an alternative embodiment of the method of the present invention, desiccation gas is delivered to multiple chambers at the same time that the desiccation gas is also being removed from multiple chambers, thereby providing substantially continuous flow of desiccation gas through the chamber. This may be possible by providing a pressure differential between the gas inlet and the gas vent. This may be done by supplying the desiccation gas to the gas inlet at a pressure that is higher than pressure within the chamber, holding a vacuum pressure at the gas vent that is lower than the pressure within the chamber, or both.

Gases suitable for use as desiccation may be any gas capable of drying a liquid sample that is also relatively inert to the sample. Thus, the desiccation gas selected for a particular application may be at least in part determined by the solvent and solutes in the liquid sample. Gases suitable for use as desiccation gas include, but are not limited to, nitrogen, air, argon and helium. The desiccation gas itself may be desiccated prior to being introduced into the desiccation device. This may be particularly advantageous if the liquid sample includes a hygroscopic or aqueous solvent.

The methods of the present invention may be used to desiccate liquid samples including solvents such as, but not limited to, water, acetonitrile, alcohols, acetic acid and trifluoroacetic acid. Liquid samples desiccated by the methods of the present invention include samples having solutes such as, but not limited to, proteins, peptides, oligonucleotides, DNA, RNA, lipids, phospholipids, steroids, hormones, other biological molecules, and labeled derivatives thereof, such as by radioactive labeling.

It may be convenient in certain embodiments of the process of the present invention to be able to control the temperature of the sample within the chamber during desiccation. Therefore, the desiccation gas may be heated or chilled outside of the chambers before being supplied to the inlets.

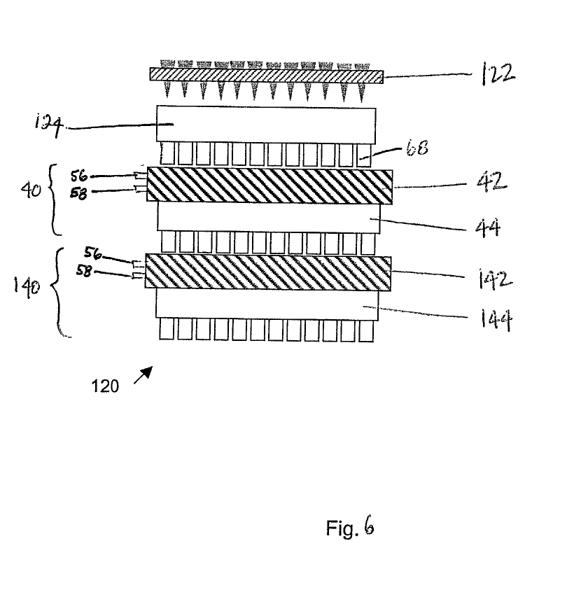

FIG. 6 provides a schematic diagram of a complete modular system 120 that includes a plurality of sample processing modules such as the processing modules described above. The system may be capable of standing free of any support or, alternatively, may be clamped or otherwise attached to a support structure such as, but not limited to, a laboratory stand or rail. Each sample processing module includes one or more sample processing elements. For example, sample processing module 124 includes one sample processing element. Sample processing module 40, however, includes a concentrator element 42 and a processing element 44. Sample processing module 140 also includes a concentrator element 142 and a processing element 144. The modular assembly of the system 120 permits customized design of the complete system for a particular application. Such a system may be designed for conducting, for example, proteomic or genomic analyses including detection or quantification of one or more particular biological molecules in a liquid sample.

Such a system may be designed to provide modular, substantially parallel, high-throughput chemical analyses. For example, a system may be designed for conducting proteomic analyses. In such a system, protein samples to be analyzed may be introduced into the modular system 120 by using, e.g., an array of micropipets 122. In the embodiment illustrated in FIG. 6, samples are introduced into the system through processing module 124. Processing module 124 has a plurality of processing chambers that may be configured to conform to the array of micropipettes 122, and adapted to perform one or more processes on the protein samples. Such processes may include, but are not limited to, diluting the sample with a buffer or other liquid solution, depleting the sample of selected components (e.g., by using affinity capture chemistry), concentrating the sample, introducing chemical modifiers into the sample, digesting the sample components with enzymes, desalting the sample solution, heating, cooling, collecting the samples for further processing, or combinations thereof Processing module 124 includes a plurality of drain ports 68, through which the samples may be transferred from processing module 124 to another module. In the embodiment shown in FIG. 6, the sample is transferred to concentrator module 42 of the processing system 40.

The drain ports 68 may be configured to be complementary to corresponding receiving structures of a subsequent sample processing module, thereby providing fluid communication between one processing module and a subsequent processing module. Such receiving structures may include the sample introduction ports 60, shown in FIG. 4. For ease of illustrattion, the system of FIG. 6 is shown in a non-integrated arrangement, i.e., the drain ports 68 of one module are shown completely external to the subsequent module. In practice, the drain ports 68 of one module may nest within the receiving structures of the subsequent module so that, when fit together in an integrated arrangement, the drain ports 68 are not visible.

In certain embodiments, the interface between the drain ports 68 and the receiving structures may form an airtight seal. When the receiving structures are prepared this way, the movement of liquid from one processing module to a subsequent sample processing module may be facilitated by providing a pressure differential between modules, thereby driving transfer of the liquid samples from one module to the next. Each module may have an inlet connection 56 and outlet connection 58 and therefore, each module may be independently connected to a source of desiccation gas or a vacuum source. Thus, a pressure differential between modules may be produced by increasing the pressure of the desiccation gas being delivered to a module, providing a vacuum in a subsequent module, or both.

Additional modules may be designed, such as sample processing module 140 shown in FIG. 6, to be integrated in a manner similar to that described above. For example, sample processing system 140 may be stacked below and in fluid communication with sample processing system 40. Each module may be interconnected in fluid communication to a subsequent module through the drain port/receiving structure configuration described above.

A controller element may be employed to regulate one or more system functions. For example, the controller element may be useful for regulating functions including, but not limited to, injecting gas into one or more desiccation chambers, creating a vacuum in all or part of the system, regulating one or more aspects of the physical environment in the processing module, providing timing to the sequence of various steps in the chemical analyses being performed, and mediating the movement of the liquid samples from module to module. Such regulation may serve to automate the chemical analyses being performed by the system in such a way as to minimize or substantially eliminate having to perform one or more of the processing steps manually. The controller element may be any suitable controller means including, but not limited to, a programmable microprocessor.

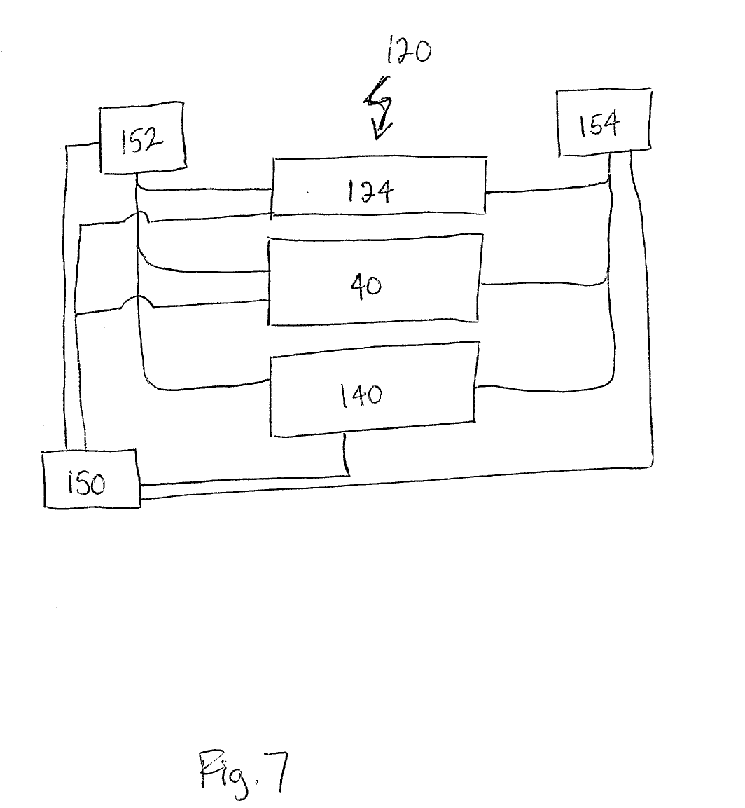

FIG. 7 illustrates the incorporation of a controller element 150 into a modular system 120, such as that shown in FIG. 6. FIG. 7 shows processing modules 124, 40 and 140, a gas source 152 and a vacuum source 154 as components of the system 120 that may be regulated by the controller element 150. The controller element 150 may be connected to a gas source 152 and thus may regulate the supply of desiccation gas or some other gas to one or more of the modules in the system 120. In other embodiments, the controller element 150 may be connected to a vacuum source 154 and thus may regulate the creation or maintainence of a vacuum in one or more modules of the system 120. In still other embodiments, the controller element 150 may be connected to one or more of the modules 124, 40 and 140, thereby regulating one or more functions of the modules described above. In still other embodiments, the controller element 150 may be connected to one or more components of the system 120 in any suitable combination.

The complete disclosures of the patents, patent documents and publications cited herein are incorporated by reference in their entirety as if each were individually incorporated. In case of conflict, the present specification will control.

Various modifications and alterations to this invention will become apparent to those skilled in the art without departing from the scope and spirit of this invention. It should be understood that this invention is not intended to be unduly limited by the illustrative embodiments and drawings set forth herein and that such drawings and embodiments are presented by way of example only with the scope of the invention intended to be limited only by the claims set forth herein as follows.

What is claimed is:

1. A desiccation device comprising:
a body that comprises a plurality of chambers wherein at least one chamber is a desiccation chamber that comprises:
i) a sidewall that at least partially defines a first volume, a second volume in direct fluid communication with the first volume, and a sample volume in direct fluid communication with the second volume, wherein the second volume separates the first volume from the sample volume;
ii) at least one gas inlet located in the sidewall of the desiccation chamber and in direct fluid communication with the first volume;
iii) a gas vent in fluid communication with the first volume; and
iv) a sample opening in fluid communication with the sample volume.

2. The device of claim 1 further comprising a supply plenum in fluid communication with a supply of desiccation gas and also in fluid communication with one or more gas inlets of one or more desiccation chambers.

3. The device of claim 1 further comprising a vent plenum in fluid communication with one or more gas vents of one or more desiccation chambers.

4. The device of claim 1 wherein at least one desiccation chamber comprises a longitudinal axis extending through the first volume, the second volume and the sample volume, and wherein the gas inlet is oriented to direct desiccation gas into the first volume in a direction that is on a plane that is substantially transverse to the longitudinal axis.

5. The device of claim 1 wherein at least one desiccation chamber sidewall comprises a portion that defines a curve having a tangent, and wherein the gas inlet is oriented to direct desiccation gas into the first volume in a direction that is substantially parallel to the tangent of the curve.

6. The device of claim 5 wherein the gas inlet is oriented to direct desiccation gas into the first volume along a line that is substantially tangential to the curve and intersects with the sidewall at the gas inlet.

7. The device of claim 1 wherein, in at least one desiccation chamber, the gas inlet is closer to the sample volume than is the gas vent.

8. The device of claim 1 wherein, in at least one desiccation chamber, the gas vent is closer to the sample volume than is the gas inlet.

9. The device of claim 1 wherein at least one desiccation chamber comprises a plurality of gas inlets.

10. The device of claim 1 wherein at least one desiccation chamber comprises a plurality of gas vents.

11. The device of claim 1 wherein at least one desiccation chamber further comprises a drain port in fluid communication with the sample volume.

12. The device of claim 1 wherein at least one desiccation chamber further comprises a membrane in fluid communication with the sample volume.

13. The device of claim 1 wherein at least one desiccation chamber further comprises a valve in fluid communication with the sample volume.

14. A sample processing module capable of processing a plurality of liquid samples, the module comprising:
at least one concentrator element comprising:
a body that comprises a plurality of concentrator chambers, each concentrator chamber comprising:
i) a sidewall located between generally opposed openings that at least partially defines a first volume,
ii) at least one gas inlet located in the sidewall and in direct fluid communication with the first volume, and
iii) a gas vent in fluid communication with the first volume; and
at least one processing element comprising a body that comprises a plurality of processing chambers formed in the body, wherein each processing chamber comprises a sample volume and at least a portion of a second volume;
wherein the at least one processing element is configured so that when the at least one concentrator element is assembled with the at least one processing element to form the module, one or more processing chambers is in direct fluid communication with one or more concentrator chambers.

15. The sample processing module of element 14 wherein at least one processing chamber in fluid communication with at least one concentrator chamber forms a desiccation chamber comprising the first volume, the second volume and the sample volume.

16. The module of claim 15 further comprising a supply plenum in fluid communication with a supply of desiccation gas and also in fluid communication with at least one desiccation chamber.

17. The module of claim 15 further comprising a vent plenum in fluid communication with at least one desiccation chamber.

18. The module of claim 15 wherein at least one desiccation chamber further comprises a longitudinal axis extending through the first volume, and wherein the gas inlet is oriented to direct desiccation gas into the desiccation chamber in a direction that is on a plane that is substantially transverse to the longitudinal axis.

19. The module of claim 15 wherein at least one desiccation chamber sidewall comprises a portion that defines a curve having a tangent, and wherein the gas inlet is oriented to direct desiccation gas into the desiccation chamber in a direction that is substantially parallel to the tangent of the curve.

20. The module of claim 19 wherein the gas inlet is oriented to direct desiccation gas into the desiccation chamber along a line that is substantially tangential to the curve and intersects with the sidewall at the gas inlet.

21. The module of claim 15 wherein, in at least one desiccation chamber, the gas inlet is closer to the processing element than is the gas vent.

22. The module of claim 15 wherein, in at least one desiccation chamber, the gas vent is closer to the processing element than is the gas inlet.

23. The module of claim 15 wherein at least one desiccation chamber comprises a plurality of gas inlets.

24. The module of claim 15 wherein at least one desiccation chamber comprises a plurality of gas vents.

25. The module of claim 14 wherein at least one processing chamber further comprises at least one drain port in fluid communication with the sample volume.

26. The module of claim 14 wherein at least one processing chamber further comprises a membrane in fluid communication with the sample volume.

27. The module of claim 14 wherein at least one processing chamber further comprises a valve in fluid communication with the sample volume.

28. The module of claim 14 wherein the concentrator element is reusable.

29. The module of claim 14 wherein the processing element is disposable after one use.

30. A sample processing system capable of processing a plurality of liquid samples comprising two or more of the sample processing modules of claim 14.

31. The system of claim 30 further comprising a supply of desiccation gas in fluid communication with at least one concentrator chamber of at least one sample processing module.

32. The system of claim 30 further comprising a control element for regulating the processing of the liquid samples.

33. The system of claim 32 wherein the control element is configured to regulate the temperature of a sample.

34. The system of claim 32 wherein the control element is configured to regulate the movement of at least one sample from one module in the system to another module in the system.

35. The system of claim 30 wherein the system further comprises delivery means for delivering one or more samples to a sample receiving module, and wherein the sample receiving module is configured for receiving one or more samples from the delivery means.

36. A method of concentrating a liquid sample, the method comprising:
providing a device comprising a plurality of chambers, wherein at least one chamber is a desiccation chamber that comprises:
i) a sidewall that at least partially defines a first volume, a second volume in direct fluid communication with the first volume, a sample volume in direct fluid communication with the second volume,
ii) at least one gas inlet located in the sidewall and in direct fluid communication with the first volume and also in fluid communication with a supply of desiccation gas, and
iii) a gas vent in direct or indirect fluid communication with the first volume;
providing a liquid sample to two or more desiccation chambers;
introducing desiccation gas through the gas inlet into the first volume of the two or more desiccation chambers to which a liquid sample has been provided, thereby concentrating the liquid samples; and
removing at least a portion of the desiccation gas through the gas vents of at least a portion of the two or more desiccation chambers to which a liquid sample has been provided;
wherein at least two liquid samples are concentrated substantially simultaneously.

37. The method of claim 36 wherein the desiccation gas is introduced to the two or more desiccation chambers to which a liquid sample has been provided substantially simultaneously.

38. The method of claim 37 wherein the desiccation gas is removed from the two or more desiccation chambers to which a liquid sample has been provided substantially simultaneously.

39. The method of claim 36 wherein the desiccation gas is removed from the two or more desiccation chambers to which a liquid sample has been provided substantially simultaneously.

40. The method of claim 36 wherein introducing the desiccation gas comprises providing a pressure differential between the gas inlet and the gas vent.

41. The method of claim 40 wherein introducing the desiccation gas comprises injecting desiccation gas into the first volume under a pressure greater than ambient pressure within the chamber.

42. The method of claim 36 wherein removing the desiccation gas comprises providing a pressure differential between the gas inlet and the gas vent.

43. The method of claim 42 wherein removing the desiccation gas comprises providing a vacuum through the vent that is at lower pressure than ambient pressure within the chamber.

44. The method of claim 36 wherein at least one desiccation chamber comprises a longitudinal axis extending through the first volume, second volume and sample volume, and wherein introducing the desiccation gas comprises directing the desiccation gas into the first volume in a direction that is substantially transverse to the longitudinal axis.

45. The method of claim 36 wherein at least one desiccation chamber sidewall comprises a portion that defines a curve having a tangent, and wherein introducing the desiccation gas comprises directing the desiccation gas into the first volume in a direction that is substantially parallel to the tangent of the curve.

46. The method of claim 45 wherein directing the desiccation gas comprises directing the desiccation gas into the first volume along a line that is substantially tangential to the curve and intersects with the sidewall at the gas inlet.

47. The method claim 36 further comprising heating the desiccation gas outside of the plurality of chambers.

48. The method claim 36 further comprising chilling the desiccation gas outside of the plurality of chambers.

49. The method claim 36 further comprising drying the desiccation gas outside of the plurality of chambers.

50. The method claim 36 wherein at least one desiccation chamber comprises a drain port in fluid communication with the sample volume, and wherein the method further comprises draining at least a portion of the sample from the at least one desiccation chamber through the drain port.

51. The method claim 50 wherein at least one desiccation chamber further comprises a membrane that separates the sample volume from the drain port and also is capable of filtering the liquid sample, and wherein the draining step comprises filtering the portion of the liquid sample being drained.

52. The method of claim 50 wherein at least one desiccation chamber further comprises an activated membrane that separates the sample volume from the drain port and also is capable of adsorbing one or more solutes of the liquid sample, and wherein the draining step comprises adsorbing one or more solutes of the sample.

53. The method of claim 50 wherein draining the liquid sample from at least one desiccation chamber is regulated by a control element.

54. The method of claim 53 wherein the control element regulates pressure inside the at least one desiccation chamber, at the drain port of the at least one desiccation chamber, or both, thereby regulating a pressure differential between the drain port and inside the desiccation chamber.

55. The method of claim 54 wherein the pressure differential is formed by increasing the pressure inside the desiccation chamber by introducing gas into the desiccation chamber.

56. The method of claim 54 wherein the pressure differential is formed by decreasing the pressure at the drain port.

57. The method of claim 36 wherein the device comprises:
a concentrator element comprising the at least one gas inlet, the gas vent and the first volume; and
a processing element comprising the second volume the sample volume and at least a portion of the second volume;
wherein the concentrator element and the processing element are separable and capable of being assembled to form the device.

58. The method of claim 36 wherein the sample comprises a protein, a peptide, an oligonucleotide, a DNA, a RNA, a lipid, a phospholipid, a steroid, a hormone, a labeled derivative of any of the foregoing, or any combination of any of the foregoing.
